(19) United States
(12) Patent Application Publication
(10) Pub. No.: US 2024/0142724 A1
(43) Pub. Date: May 2, 2024

(54) MPO CONNECTOR AND PUSH-PULL BOOT THEREFOR

(71) Applicant: Senko Advanced Components, Inc., Hudson, MA (US)

(72) Inventor: Siu Kei MA, Kowloon (HK)

(21) Appl. No.: 18/497,197

(22) Filed: Oct. 30, 2023

Related U.S. Application Data
(60) Provisional application No. 63/420,218, filed on Oct. 28, 2022.

(51) Int. Cl. G02B 6/38

(52) U.S. Cl. CPC G02B 6/3893; G02B 6/3885; G02B 6/3825

(57) ABSTRACT

An MPO connector has an elongated outer housing and a push-pull boot. The front end portion of the push-pull received in the interior of the extended rear portion of the outer housing. The front end portion of the push-pull boot is linked to the opposing side portions of the outer housing such that the outer housing moves backward in relation to the main body when the push-pull boot is pulled backward. The front end portion of the push-pull boot can comprise opposing side walls with opposing side tabs projecting outward for operably connecting the push-pull boot to the elongated outer housing of the MPO connector.

### CROSS-REFERENCE TO RELATED APPLICATION

This application claims priority to U.S. Provisional Patent Application No. 63/420,218, filed Oct. 28, 2022, which is hereby incorporated by reference in its entirety.

### FIELD

This disclosure generally pertains to an MPO connector and a push-pull boot for an MPO connector.

### BACKGROUND

Multifiber push on (“MPO”) interconnect systems are currently the most widely used connection system for passive multifiber fiber optic network applications. MPO connectors allow for simultaneously connecting multiple fibers in a fiber optic network by simply pushing the MPO connector into an MPO receptacle. This causes receptacle latch arms to engage recesses along the sides of the main body of the MPO connector. Then a spring-loaded outer housing of the MPO connector moves forward to cover the latch arms and locks the latch arms to the main body. To remove an MPO connector from the MPO receptacle, a user pulls backward on the outer housing, overcoming the spring force so that the outer housing moves backward in relation to the main body. This uncovers the receptacle latch arms so that they can spread outward and release the main body from the connector.

To provide better push-in and pull-out access for MPO connectors in high density applications, pull tabs are available that affix to the outer housing. Recently, the fiber optic networking industry has developed a preference for push-pull boots instead of separate pull tabs. Some MPO connectors with push-pull boots are now available. These possess a front attachment feature that secures to the outside of the MPO outer housing.

### SUMMARY

In one aspect, an MPO connector comprises a multifiber ferrule. A main body receives the multifiber ferule. The main body has opposing side walls on opposite sides of the multifiber ferrule. Each of the opposing side walls defines a latch recess. The latch recesses of the opposing side walls are configured for receiving opposing latch arms of a mating receptacle. An outer housing has an interior receiving a portion of the main body. The outer housing is movably connected to the main body for longitudinal movement in relation to the main body through a range of motion that includes a front position and a rear position. The outer housing has opposing side portions configured to cover the opposing latch arms of the mating receptacle received in the latch recesses of the opposing side walls of the main body when the outer housing is in the front position and to uncover the opposing latch arms as the outer housing slides backward from the front position toward the rear position. A push-pull boot has a front end portion received in the interior of the outer housing. The front end portion is linked to the opposing side portions of the outer housing such that the outer housing moves backward in relation to the main body when the push-pull boot is pulled backward.

In another aspect, a push-pull boot for an MPO connector comprises a front portion configured for reception in an elongated outer housing of an MPO connector. The push-pull boot includes a strain relief sleeve extending rearward from the front portion. The front portion is entirely in front of the strain relief sleeve and is more rigid than the strain relief sleeve. The front portion defines a central opening and comprises top and bottom walls above and below the central opening and opposing side walls on opposite sides of the central opening. The top and bottom walls define a height of the push-pull boot and the opposing side walls defining a width of the push-pull boot. The width is greater than the height. The side walls comprise opposing side tabs projecting outward for operably connecting the push-pull boot to the elongated outer housing of the MPO connector.

Other aspects will be in part apparent and in part pointed out hereinafter.

### BRIEF DESCRIPTION OF THE DRAWINGS

FIG. 1 is a perspective of an MPO connector in accordance with the present disclosure;

FIG. 2 is an exploded perspective of the MPO connector;

FIG. 3 is an exploded top plan view of the MPO connector;

FIG. 4 is a bottom plan view of the MPO connector;

FIG. 5 is a side elevation of the MPO connector;

FIG. 6 is a perspective of the MPO connector showing a push-pull boot thereof separated from a remainder of the connector;

FIG. 7 is a top plan view of the MPO connector in the configuration of FIG. 6;

FIG. 8 is a perspective of a main body of the MPO connector;

FIG. 9 is a top plan view of the main body;

FIG. 10 is a perspective of an elongated outer housing of the MPO connector;

FIG. 11 is another perspective of the elongated outer housing;

FIG. 12 is a perspective of the push-pull boot;

FIG. 13 is a top plan view of the push-pull boot;

FIG. 14 is a longitudinal cross section of the MPO connector;

FIG. 15 is an enlarged longitudinal cross section of a front portion of the MPO connector;

FIG. 16 is a perspective showing the MPO connector approaching an MPO adapter;

FIG. 17 is a perspective similar to FIG. 16, but wherein the front portion of the main body has been inserted into a receptacle of the MPO adapter to a point where the elongated outer housing has not yet been displaced backward by the MPO adapter;

FIG. 18 is a perspective similar to FIGS. 16 and 17, but wherein the main body has been inserted further into the receptacle so that the MPO adapter has displaced the elongated outer housing backward;

FIG. 19 is a perspective similar to FIGS. 16-18 showing the MPO connector fully mated with the MPO adapter;

FIG. 20 is a perspective showing two MPO connectors of the type depicted in FIG. 1 mated with the MPO adapter;

FIG. 21 is a perspective similar to FIG. 20, but wherein one of the MPO connectors has been extracted;

FIG. 22 is a perspective of another embodiment of an MPO connector in accordance with the present disclosure;

FIG. 23 is a perspective of another embodiment of an MPO connector in accordance with the present disclosure; and

FIG. 24 is a perspective of another embodiment of an MPO connector in accordance with the present disclosure.

Corresponding parts are given corresponding reference characters throughout the drawings.

### DETAILED DESCRIPTION

The inventor believes that there is room for improvement in existing push-pull boot systems for MPO connectors. For example, commercially available push-pull boots for MPO connectors that attach to the exterior of the MPO outer housing are bulky, and increase the overall footprint of the connector in relation to standard MPO connectors without push-pull boots.

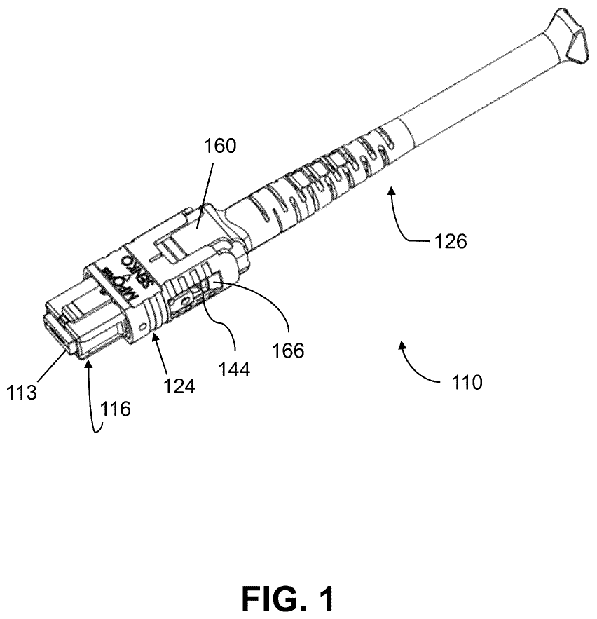

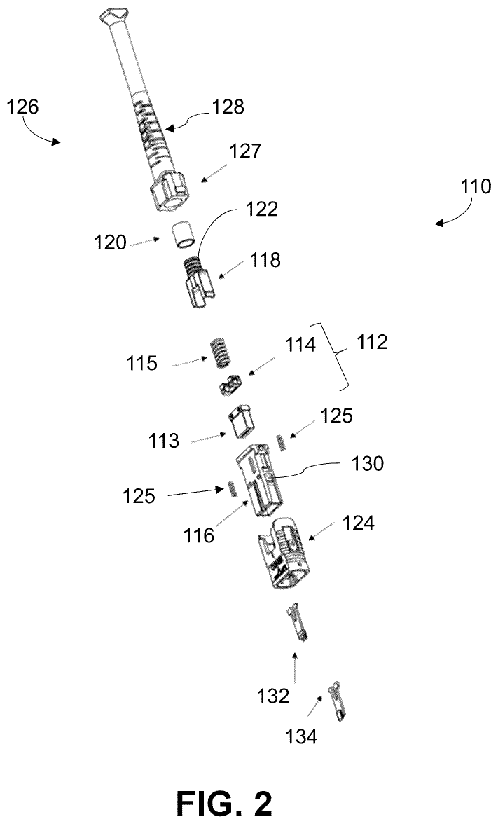

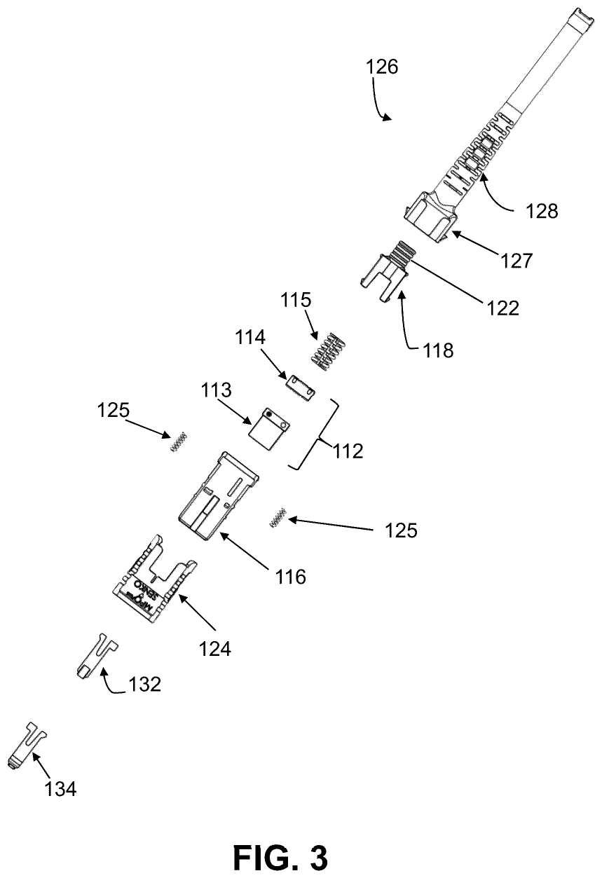

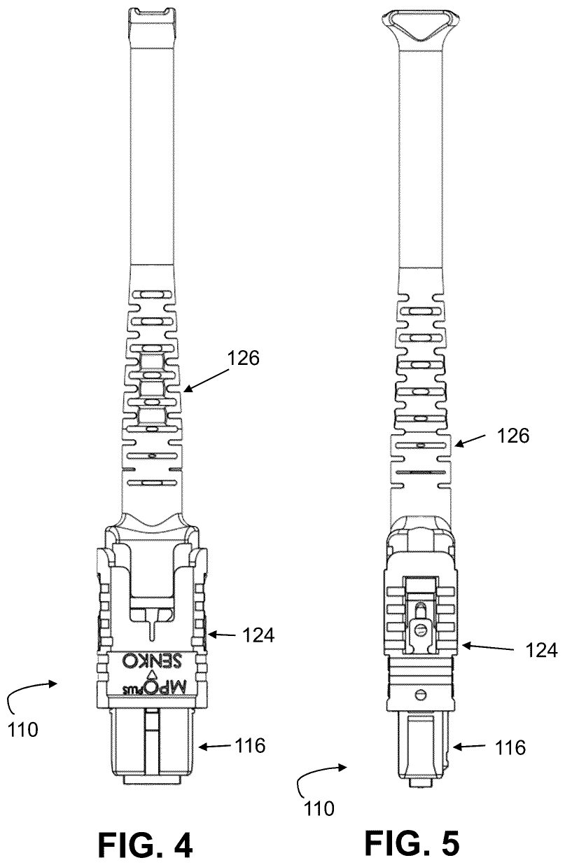

Referring to FIGS. 1-6, an exemplary embodiment of an MPO connector in accordance with the present disclosure is generally indicated at reference number 110. The MPO connector 110 comprises a multifiber ferrule assembly 112 (including an MT ferrule 113 and a pin keeper 114), a ferrule spring 115, and a main body 116 having an interior that receives the multifiber ferrule assembly and the ferrule spring. A back body 118 is coupled to a rear end portion of the main body and loads the ferrule spring 115 for yieldably biasing the multifiber ferrule assembly 112 forward in the main body 116. A crimp ring 120 crimps cable strength members (not shown) onto a back post 122 of the back body 118. An elongated outer housing 124 is movably disposed on the main body 116. Housing springs 125 are loaded between the outer housing 124 and the main body 116 for yieldably biasing the outer housing forward in relation to the main body. A rear end portion of the elongated outer housing 124 projects rearward beyond a rear end of the main body 116. A push-pull boot 126 has a front end portion 127 for reception in the interior of the rearward projecting portion of the outer housing 124, where it operably couples to the outer housing as described in further detail below. The push-pull boot also includes a strain relieve sleeve 128 for providing strain relief to the cable.

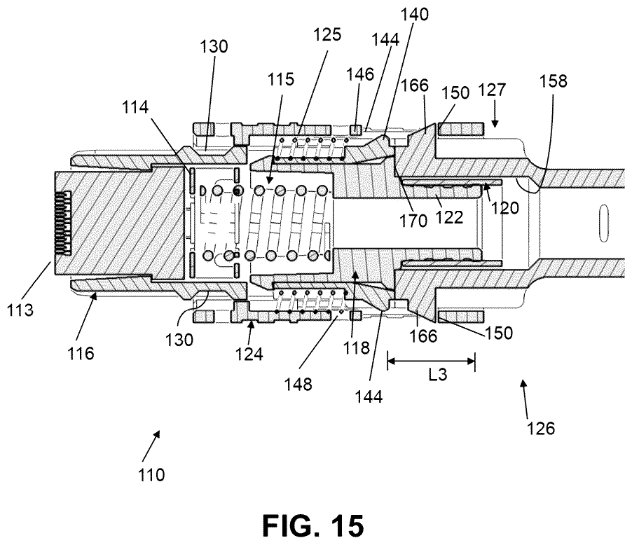

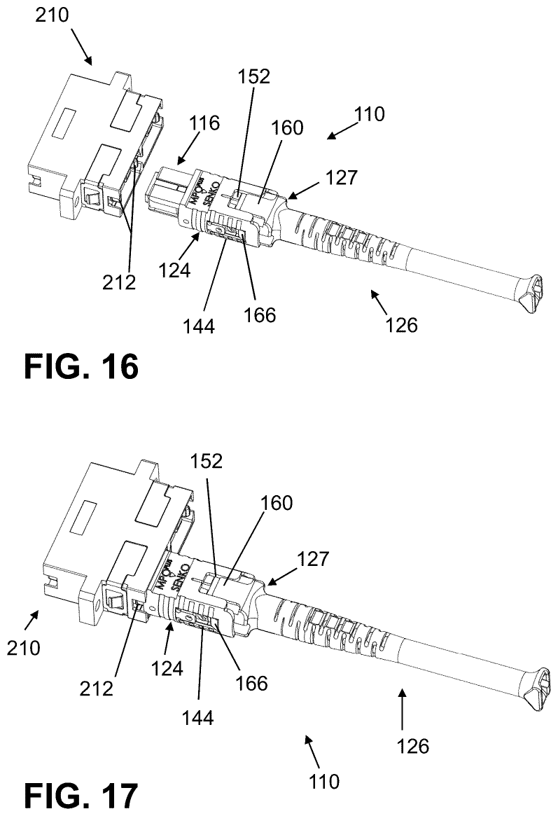

The MPO connector 110 is configured to mate with standard MPO receptacles, such as the MPO adapter 210 show in FIGS. 16-21. Accordingly, the main body 116 has opposing side walls on opposite sides of the multifiber ferrule 113, and each side wall defines a respective latch recess 130 (see FIG. 15). The latch recesses 130 are configured for receiving opposing adapter latch arms 212 (see FIG. 16) of the mating adapter 210. To facilitate a secure but releasable connection, the outer housing 124 is movably connected to the main body 116 for longitudinal movement in relation to the main body through a range of motion that includes a front position and a rear position. The outer housing 124 has opposing side portions configured to cover the opposing latch arms 212 of the mating receptacle received in the latch recesses 130 of the opposing side walls of the main body 116 when the outer housing is in the front position (see FIG. 19) and to uncover the opposing latch arms as the outer housing slides backward from the front position toward the rear position (see FIG. 17).

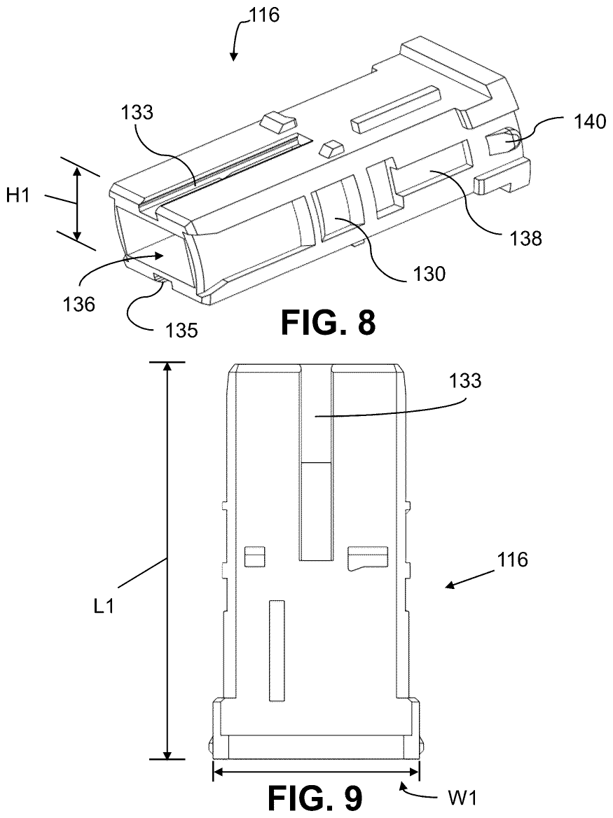

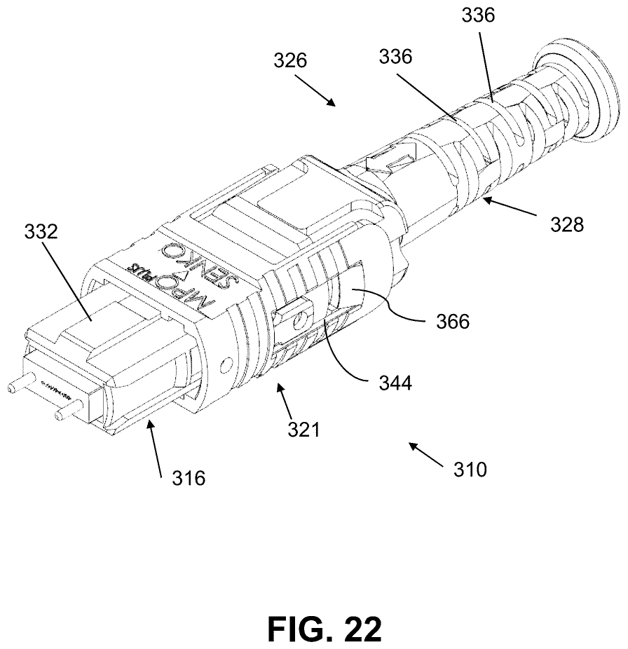

In addition to the standard MPO latch features, the illustrated MPO connector 110 comprises standard polarity features to ensure that the MPO connector is inserted into the MPO adapter 210 in the upright (not inverted) orientation. In the example shown in FIGS. 1-21, the MPO connector 110 includes a polarity change system. Any suitable polarity change system can be used without departing from the scope of the disclosure. But in the illustrated embodiment, the MPO connector 110 has a toolless polarity change system that is essentially the same as the one used in the MPO Plus Connector sold by Senko Advanced Components. This type of polarity change system includes upper and lower polarity keys 132, 134 slidably received in grooves 133, 135 (FIG. 8) formed on upper and lower walls of the main body 116. As will be known to those skilled in the art, the Senko MPO Plus polarity change system is configured so that the keys 132, 134 are normally locked in either a front or a rear position, but they can be released to facilitate polarity change by moving the outer housing 124 backward in relation to the main body 116 to the rear position of its range of motion. This disclosure is not limited to MPO connectors with polarity change systems. On the contrary, as shown in FIG. 22, an alternative embodiment of an MPO connector 310 is contemplated that comprises a single polarity key 332 fixed on the main body 316.

Referring to FIGS. 8-9, the main body 116 has a length L1 extending from a front end to a rear end, a width W1 extending between the side walls, and a height H1 extending from the upper wall to the lower wall. The width W1 is greater than the height H1. The side walls and the upper and lower walls define a rectangular passage 136 that is wider than it is tall. The main body 116 is configured to receive the multifiber ferrule 113 in the passage 136 so that the fiber alignment axis of the ferrule (typically, an axis that crosses through two guide pin openings of the multifiber ferrule) extends widthwise. Behind the latch recesses 130, each side wall of the main body 116 defines a groove 138 for receiving a respective housing spring 125. And behind the grooves 138, each side wall defines a cleat projection 140 like the one used in Senko MPO Plus connectors to retain an outer housing in a rear position during a polarity change operation.

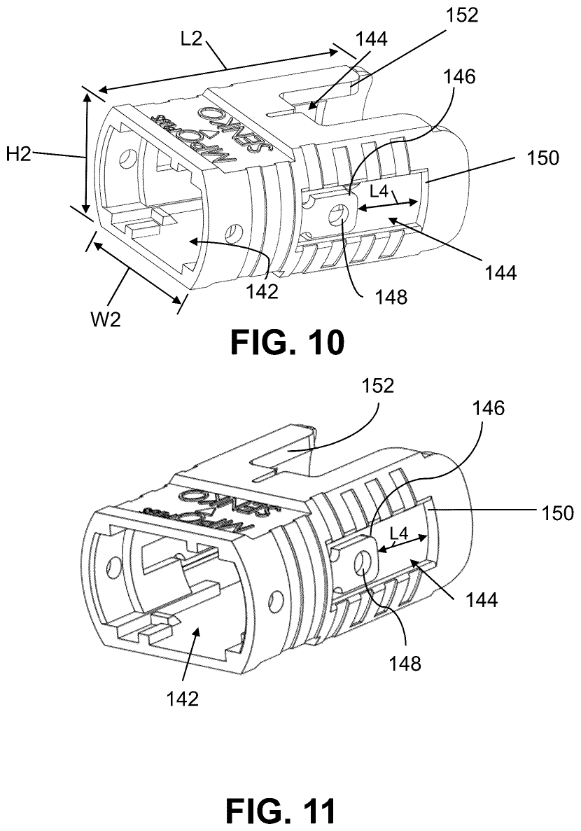

Referring to FIGS. 10-11, the elongated outer housing 124 has a length L2 extending from a front end to a rear end, a width W2 extending between opposing side portions, and a height H2 extending from a top portion to a bottom portion of the outer housing. The width W1 is greater than the height H1. The elongated outer housing 124 defines a central passage 142 in which to receive a portion of the main body 116. The front portion of the outer housing 124 includes various internal features that interface with the main body 116 and polarity keys 132, 134 to facilitate polarity change in essentially the same way as the outer housing of a Senko MPO Plus connector.

The outer housing 124 is a single-piece (e.g., one molded piece of monolithic plastic) component, much like the outer housing of conventional MPO connectors, but its length L2 is substantially greater than that of a conventional MPO outer housing. In one or more embodiments, the length L2 of the outer housing 124 is greater than 18 mm, greater than 19 mm, greater than 20 mm, greater than 21 mm, greater than 22 mm, greater than 23 mm, greater than 24 mm, or greater than 25 mm. The length L2 will typically be less than 40 mm. Accordingly, the elongated outer housing 124 is sized and arranged so that the rear end portion of the outer housing protrudes rearward beyond the rear end of the main body 116, as shown in FIG. 15. In FIG. 15, the outer housing 124 is shown in the forward position of its range of motion. In the forward position, the elongated outer housing 124 protrudes beyond the rear end of the main body 116 along a protruding length L3. In one or more embodiments, the protruding length L3 is greater than 5 mm, greater than 6 mm, greater than 7 mm, greater than 8 mm, greater than 9 mm, greater than 10 mm. The protruding length L3 will typically be less than 20 mm.

Referring again to FIGS. 10 and 11, the opposing side portions of the outer housing comprise opposing slots 144. The opposing slots have front portions, and the opposing side portions of the outer housing 124 comprise flexible retention flaps 146 in the front portions of the opposing slots 144. The front ends of the flexible retention flaps 146 are bendably connected to the remainder of outer housing 124 by living hinges. The flexible retention flaps 146 function essentially the same way as the flexible retention flaps of the Senko MPO Plus connector. They define openings 148 and are configured to snap over the cleats 140 of the main body 116 when the outer housing 124 is displaced backward to the rear position so that the cleats are received in the openings. The cleats 140 thus engage the flexible retention flaps 146 for retaining the outer housing 124 in the rear position during a polarity change operation. A generally forward facing surface of each cleat 140 is formed as a ramp to wedge the flexible retention flaps 146 outwardly as the outer housing 124 moves rearwardly with respect to the main body 116.

The opposing side portions of the outer housing 124 have front facing surfaces 150 that define rear ends of the slots 144. As will be explained in further detail below, the front facing surfaces 150 are configured to link the opposing side portions of the outer housing 124 to the push-pull boot 126 so that the outer housing will move backward in relation to the main body 116 when the push-pull boot is pulled backward. Each of the slots 144 has an open track length L4 extending from the front facing surface 150 to the rear end of the flap 146. As will be explained in further detail below, the open track length L4 provides clearance so that the outer housing 124 can be displaced rearward in relation to the push-pull boot 126 as the push-pull boot is used to push the MPO connector 110 into the adapter 210.

In the illustrated embodiment, the top and bottom portions of the outer housing 124 define rear cutouts 152 opening rearwardly toward the push-pull boot 126. The cutouts 152 provide clearance to allow for backward displacement of the elongated outer housing 124 as the connector 110 is pushed into a mating receptacle such as the MPO adapter 210.

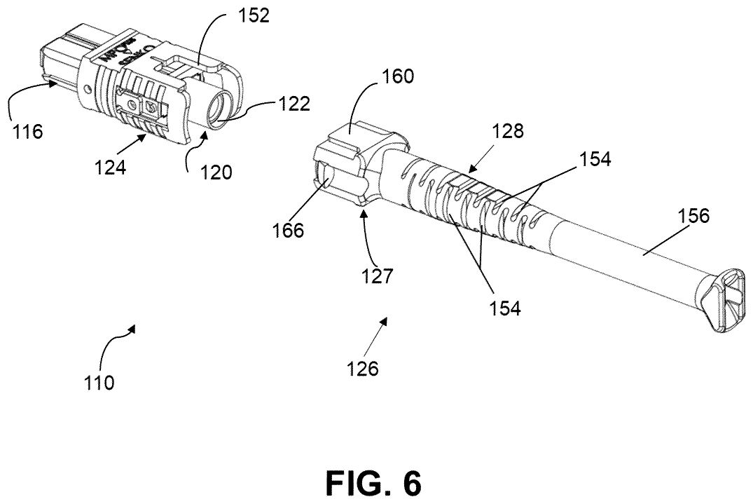

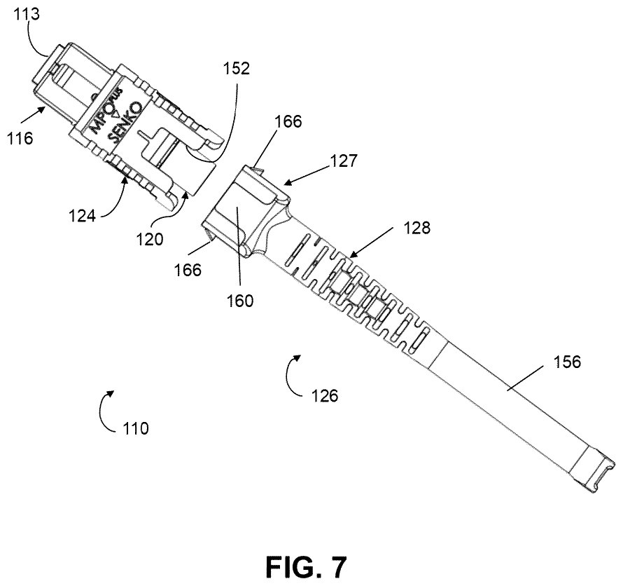

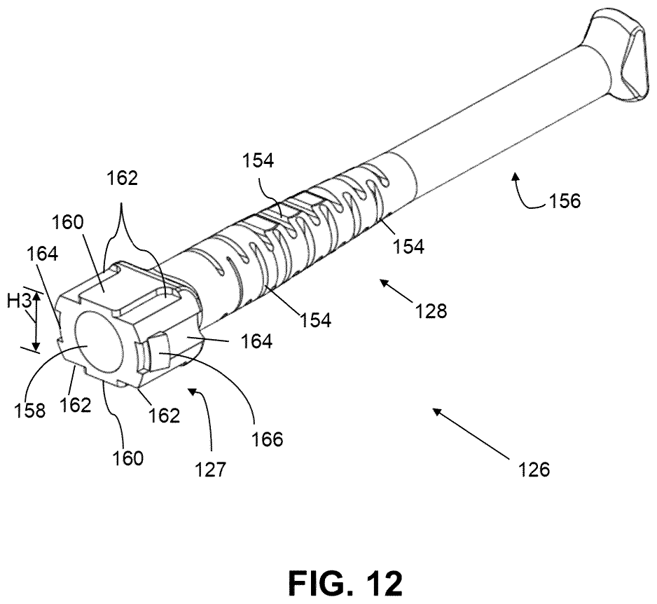

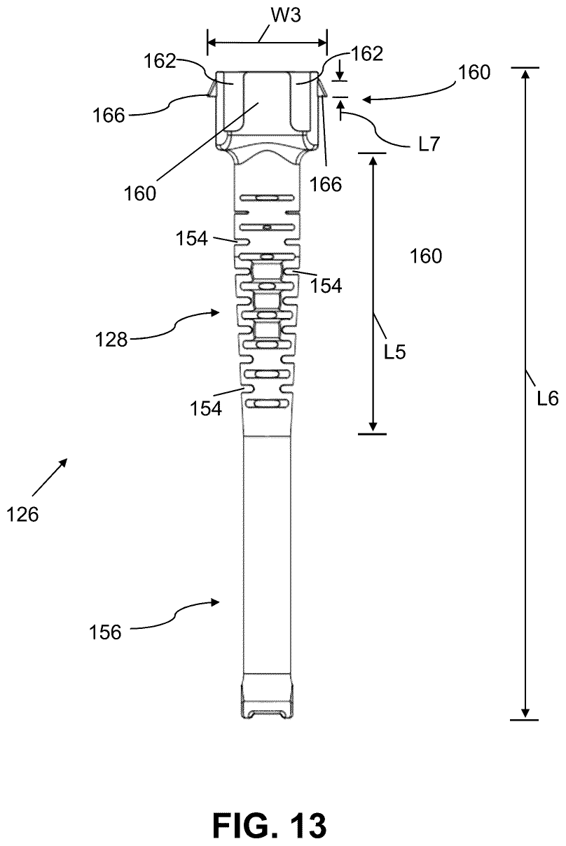

Referring to FIGS. 12-13, the front portion 127 of the push-pull boot 126 is configured for reception in the outer housing 124 and the strain relief sleeve 128 extends rearward from the front portion. The front portion 127 is entirely in front of the strain relief 128 sleeve and is more rigid than the strain relief sleeve. The more flexible strain relief sleeve 128 has a length L5 extending from the front end portion 127 to a sleeve rear end. The strain relief sleeve 128 comprises strain relief openings 154 spaced apart along its length L5. In FIGS. 6 and 7, the push-pull boot 126 comprises a solid tube 156 that extends further rearward from the rear end of the strain relief sleeve 128. The solid tube 156 is devoid of strain relief openings. In certain embodiments, the solid tube 156 is at least one-fourth of an overall length L6 of the push-pull boot 126. This disclosure is not limited to push-pull boots that include relatively long solid tubes extending rearward from the sleeve rear end of a strain relief sleeve. On the contrary, as shown in FIG. 22, the MPO connector 310 comprises a push-pull boot 326 comprising a strain relief sleeve 328 (with strain relief holes 336 along its length) that extends rearward from the front end portion 327 to the rear end of the push-pull boot.

Referring again to FIGS. 12 and 13, the front portion 127 of the push-pull boot 126 defines a central opening 158. The front portion 127 comprises top and bottom walls above and below the central opening and opposing side walls on opposite sides of the central opening. The top and bottom walls are spaced apart along a height H3 of the front portion, and the opposing side walls are spaced apart along a width W3. The width W3 is greater than the height H3. The height H3 is less than or substantially equal to the height H2 of the outer housing 124 (e.g., in certain embodiments height H3 is 95%-102% or 95%-100% of height H2). The width W3 is likewise less than or substantially equal to the width W2 of the outer housing 124 (e.g., in certain embodiments width W3 is 95%-102% or 95%-100% of width H2).

The top and bottom walls of the boot front portion 127 comprise external central bosses 160 and opposing external recessed regions 162 on opposite sides of the central bosses. The side walls comprise central longitudinal grooves 164 and opposing side tabs 166 projecting outward from the central longitudinal grooves. The side tabs 166 have a relatively short length L7. The rear ends of the side tabs are substantially orthogonal to the length L7. The outer faces of the side tabs 16 angle inward as they extend forward from the rear ends, forming a wedge shape.

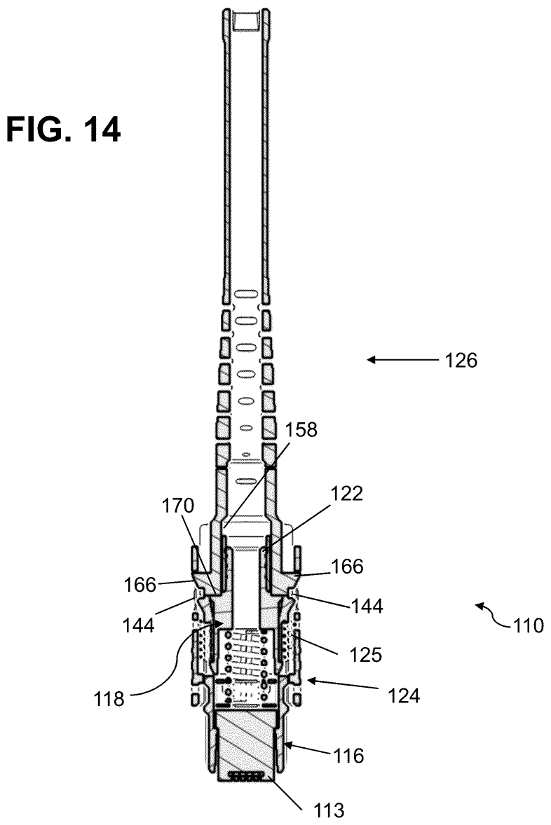

Referring to FIGS. 14-15, the MPO connector is shown with the housing springs 125 biasing the housing 124 forward to the front position of its range of motion. The forward facing surfaces 150 at the rear ends of the housing slots 144 press forward against the rear ends of the side tabs 166 so that the push-pull boot 126 is also in its front position. The engagement between the rearward facing rear ends of the opposing side tabs 166 and the forward facing surfaces 150 links the push-pull boot 126 to the outer housing 124 so that the outer housing can move backward in relation to the main body 116 when the push-pull boot is pulled backward. In the front position, the front end face of the push-pull boot 126 engages a rear shoulder 170 of the back body 118 and the front portion 127 of the push-pull boot 126 receives the back post 122 and crimp ring 120 in the passage 158. From the position shown in FIGS. 14-15, the push-pull boot can be used to push the connector 110 into the receptacle of a mating adapter 210.

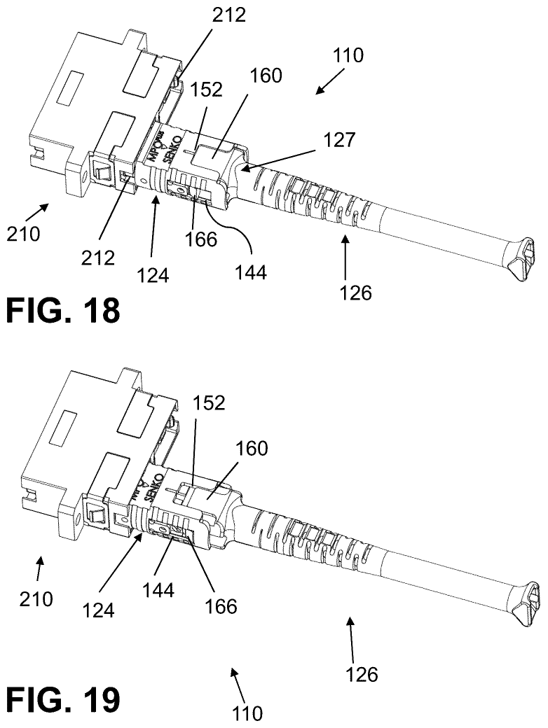

FIGS. 16-18 show how the MPO connector 110 is inserted into the adapter 210. The user can grip the connector 110 by the push-pull boot 126 and push the connector forward into the adapter 210 (or other receptacle). As shown in FIG. 17, the front end portion of the main body 116 enters the adapter 210 until the tips of the adapter latch arms 212 engage the outer housing 124. Further insertion while gripping the boot 126 causes the adapter latch arms 212 to displace the outer housing 124 rearward in relation to the main body 116 and the boot 126 until the adapter latch arms snap into the recesses 130 on the sides of the main body 116. As can be seen by comparing FIGS. 17 and 18, the relatively long open track lengths L4 of the slots 144 provide clearance for the side tabs 166 as the outer housing 124 is displaced backward. In addition, the cutouts 152 provide clearance for the bosses 160 as the outer housing 124 is displaced backward. After the adapter latch arms 212 snap into the recesses 130, the front end portion of the outer housing 124 can clear the tips of the adapter latch arms 212. The housing springs 125 urge the outer housing 124 back to its forward position as shown in FIG. 19. The front end portion of the outer housing 124 covers the adapter latch arms 212 to lock the connector 110 in mated relation with the adapter 210.

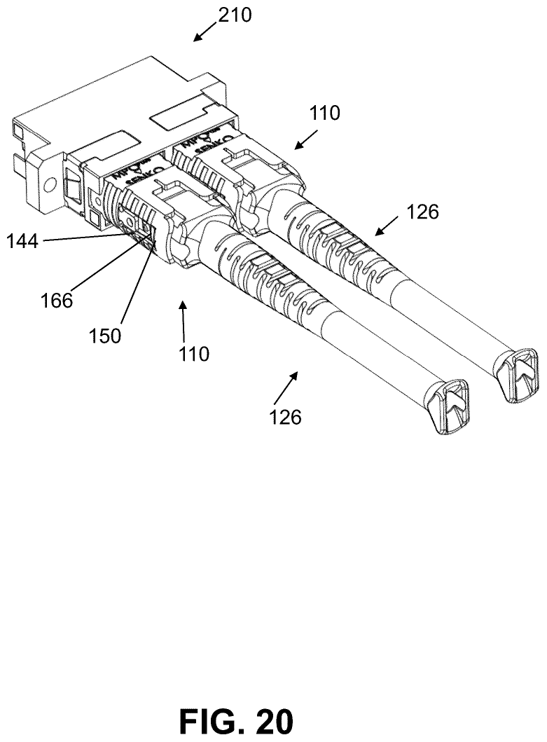

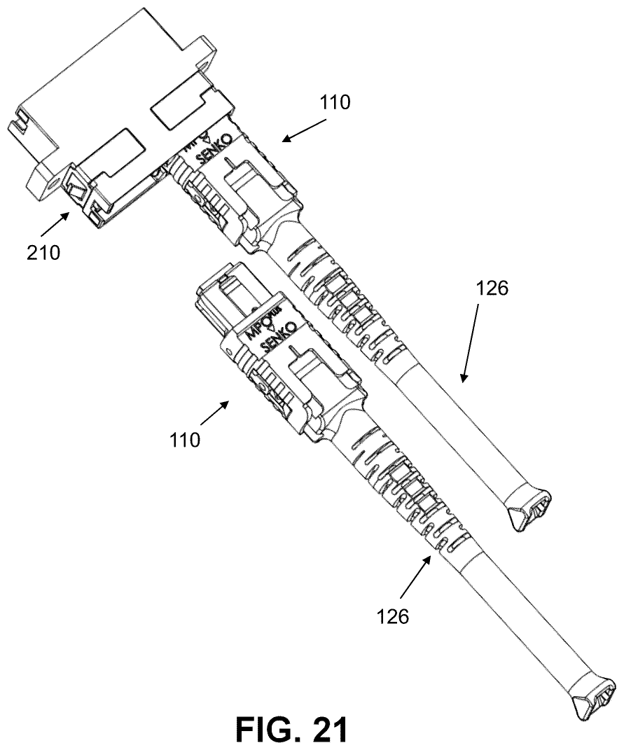

FIGS. 20 and 21 illustrate how the push-pull boot MPO connectors 110 are easy to extract, even when installed in high density applications. A user simply grips one of the push-pull boots 126 and pulls rearward. The rear ends of the side tabs 166 engage the forward facing surfaces 150 at the rear ends of the slots 144, which links the push-pull boot 126 to the outer housing 124. The push-pull boot 126 and the outer housing 124 move backward together in relation to the main body 116 until the front end portion of the outer housing 124 uncovers the adapter latch arms 212. When the outer housing 124 is out of the way, the adapter latch arms 212 can spread to release the main body 116 for extraction of the connector 110 from the adapter 210. As shown in FIGS. 20 and 21, the push-pull boot MPO connectors 110 are received in the mating adapter 210 in a horizontal orientation. However, this is for illustrative purposes only, the push-pull boot connectors 110 may be received in the mating adapter in a vertical orientation, i.e., after being rotated 90 degrees, to obtain a higher density.

As mentioned above, it is envisioned that various modifications could be made to the MPO connector 110 without departing from the scope of the disclosure. For example, the connector 310 illustrated in FIG. 22 is similar to the connector 110, with some differences still encompassed in the scope of this disclosure Like the connector 110, the connector 310 includes an elongated outer housing 324 movably disposed on a main body 316. Like the elongated outer housing 124, the elongated outer housing 324 has side portions with slots 344 to operably couple to the side tabs 366 on a front portion 327 of the push-pull boot 326. The MPO connector 310 differs from the connector 110, however, in that it lacks a polarity change system and in that the boot 326 lacks a solid tube behind the strain relief section 328.

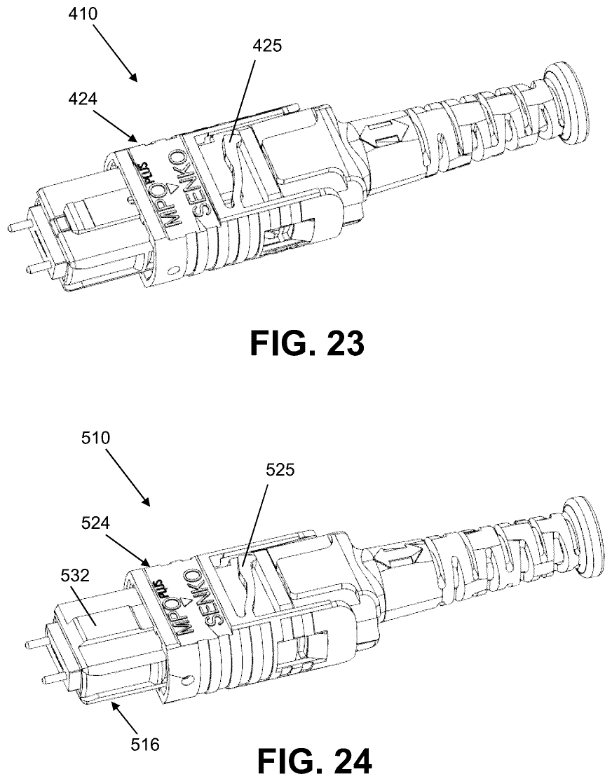

FIG. 23 illustrates another embodiment of a connector 410 according to the present disclosure. The connector 410 is similar to the connector 110 except that, instead of using coil springs 125 to bias the elongated outer housing 424 forward, the connector 410 comprises an integrally molded housing spring 425 of the type disclosed in U.S. Pat. No. 10,295,759 B2, which is hereby incorporated by reference in its entirety. Like the connector 110, the connector 410 comprises the polarity change system of an MPO Plus connector.

FIG. 24 illustrates still embodiment of a connector 510 according to the present disclosure. The connector 510 is similar to the connector 110 except that, instead of using coil springs 125 to bias the elongated outer housing 524 forward, the connector 410 comprises an integrally molded housing spring 525 of the type disclosed in U.S. Pat. No. 10,295,759 B2. Like the connector 310, the connector 510 comprises a single polarity key 532 fixed on the main body 516 and lacks a polarity change system.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. An MPO connector comprising:
a multifiber ferrule;
a main body receiving the multifiber ferule, the main body having opposing side walls on opposite sides of the multifiber ferrule, each of the opposing side walls defining a latch recess, the latch recesses of the opposing side walls configured for receiving opposing latch arms of a mating receptacle;
an outer housing having an interior receiving a portion of the main body, the outer housing being movably connected to the main body for longitudinal movement in relation to the main body through a range of motion that includes a front position and a rear position, the outer housing having opposing side portions configured to cover the opposing latch arms of the mating receptacle received in the latch recesses of the opposing side walls of the main body when the outer housing is in the front position and to uncover the opposing latch arms as the outer housing slides backward from the front position toward the rear position; and
a push-pull boot having a front end portion received in the interior of the outer housing, the front end portion being linked to the opposing side portions of the outer housing such that the outer housing moves backward in relation to the main body when the push-pull boot is pulled backward.

2. The MPO connector of claim 1, wherein the front end portion of the push-pull boot comprises opposing side tabs.

3. The MPO connector of claim 2, wherein the opposing side portions of the outer housing comprise opposing elongate slots, the opposing side tabs being received in the opposing elongate slots.

4. The MPO connector of claim 3, wherein the opposing side tabs have a length and the opposing slots have a length greater than the opposing side tabs.

5. The MPO connector of claim 4, wherein the MPO connector is configured to be pushed into the mating receptacle by the push-pull boot, wherein outer housing is configured so that as the MPO connector is pushed into the mating receptacle by the push-pull boot, the outer housing is displaced rearward by the mating receptacle in relation to the main body and the push-pull boot.

6. The MPO connector of claim 5, wherein the opposing side tabs slide forward along the opposing slots as the outer housing is displaced rearward by the mating receptacle in relation to the main body and the push-pull boot.

7. The MPO connector of claim 3, wherein each of the opposing side portions have front facing surfaces at rear ends of the opposing slots and wherein the opposing side tabs have rearward facing rear ends, the rearward facing rear ends configured to engage the forward facing surfaces to link the push-pull boot to the outer housing such that the outer housing moves backward in relation to the main body when the push-pull boot is pulled backward.

8. The MPO connector of claim 3, wherein the opposing slots have front portions and the opposing side portions comprise flexible retention flaps in the front portions of the opposing slots.

9. The MPO connector of claim 8, wherein sides of the main body comprise cleats configured to engage the flexible retention flaps for retaining the outer housing in the rear position of the range of motion.

10. The MPO connector of claim 1, wherein the outer housing comprises top and bottom portions extending widthwise between the opposing side portions, wherein the top and bottom portions define rear cutouts opening rearwardly toward the push-pull boot.

11. The MPO connector of claim 1, wherein the front portion of the push-pull boot defines a central opening and comprises top and bottom walls above and below the central opening and opposing side walls on opposite sides of the central opening.

12. The MPO connector of claim 11, wherein the top and bottom walls of the front portion comprise external central bosses and opposing external recessed regions on opposite sides of the external central bosses.

13. The MPO connector of claim 11, wherein the side walls comprise central longitudinal grooves and opposing side tabs projecting outward from the central longitudinal grooves.

14. The MPO connector of claim 1, further comprising a polarity change system including upper and lower polarity keys slidably connected to the main body.

15. The MPO connector of claim 1, further comprising a single polarity key fixed on the main body.

16. The MPO connector of claim 1, wherein the push-pull boot comprises a strain relief portion and a solid tube extending rearward from the strain relief portion.

17. A push-pull boot for an MPO connector, the push-pull boot comprising:
a front portion configured for reception in an elongated outer housing of an MPO connector, the push-pull boot including a strain relief sleeve extending rearward from the front portion, the front portion being entirely in front of the strain relief sleeve and being more rigid than the strain relief sleeve,
the front portion defining a central opening and comprising top and bottom walls above and below the central opening and opposing side walls on opposite sides of the central opening, the top and bottom walls defining a height of the push-pull boot and the opposing side walls defining a width of the push-pull boot, the width being greater than the height,
wherein the side walls comprise opposing side tabs projecting outward for operably connecting the push-pull boot to the elongated outer housing of the MPO connector.

18. The push-pull boot of claim 17, wherein the strain relief sleeve has a length extending from the front end portion to a sleeve rear end, the strain relief sleeve comprising strain relief openings spaced apart along the length.

19. The push-pull boot of claim 18, wherein the rear end portion comprises a solid tube extending rearward from the sleeve rear end, the push-pull boot having an overall length and the solid tube being at least one-fourth of the overall length.

20. The push-pull boot of claim 18, wherein the sleeve rear end is at the rear end portion of the push-pull boot.
